(19) United States
(12) Patent Application Publication
(10) Pub. No.: US 2023/0054561 A1
(43) Pub. Date: Feb. 23, 2023

(54) SLURRY HYDROCRACKING OF PYROLYSIS OIL AND HYDROCARBON FEEDSTOCK, SUCH AS PETROLEUM DERIVED FEEDSTOCK

(71) Applicant: PREEM AKTIEBOLAG, Stockholm (SE)

(72) Inventors: Niklas Sören BERGVALL, Piteå (SE); Carl Fredrik WEILAND, Norrfjärden (SE); Olov Gustav Wilhelm ÖHRMAN, Göteborg (SE)

(21) Appl. No.: 17/792,096

(22) PCT Filed: Feb. 5, 2021
(86) PCT No.: PCT/EP2021/052800

§ 371 Date: Jul. 11, 2022

(30) Foreign Application Priority Data
Feb. 5, 2020 (EP) 20155670.1

(51) Int. Cl. C10G 1/00; C10G 3/00; C10G 47/26; C10G 47/32; C10L 1/02

(52) U.S. Cl. CPC C10G 1/002; C10G 3/50; C10G 3/56; C10G 47/26; C10G 47/32; C10L 1/02; C10G 2300/1011; C10G 2300/1074; C10G 2300/1077; C10G 2300/4006; C10G 2300/4018; C10G 2400/02; C10G 2400/04; C10L 2290/56

(57) ABSTRACT

A process of producing a hydrocracking product in a slurry hydrocracking reactor. A pyrolysis oil, a hydrocarbon feedstock, and a hydrocracking catalyst is provided. The pyrolysis oil is combined with the hydrocarbon feedstock and the hydrocracking catalyst, the pyrolysis oil being maintained at a temperature of less than 100° C. until the pyrolysis oil contacts both the hydrocarbon feedstock and the hydrocracking catalyst. The hydrocarbon feedstock and the pyrolysis oil are hydrocracked in the slurry hydrocracking reactor in the presence of the hydrocracking catalyst and hydrogen gas. A fuel precursor obtainable by the process.

### TECHNICAL FIELD

The present invention relates to a slurry hydrocracking process of hydrocarbon feedstock, such as a petroleum derived feedstock, and pyrolysis oil.

### BACKGROUND

Global fossil energy accounted for about 81% of primary energy in 2014 (oil 31%, coal 29% and natural gas 21%) and is believed to still be the dominant source of energy in 2035. In Sweden, one of the government's national targets is that the fossil greenhouse gas emissions from domestic transport (excluding domestic aviation) will be reduced by at least 70% by 2030 compared with 2010, which will require great efforts. As an example, in 2015 the transport sector accounted for nearly a quarter (24%) of Sweden's total final energy consumption with road transport as the dominant sector accounting for 94% of this. The share of biofuels in domestic transport sector in 2015 was 15%.

However, in order to reach the goal of reduced fossil greenhouse gas emissions, there is a need for identify renewable biological sources for fuel production.

Materials such as biomass-derived pyrolysis oils have been identified as possible biorenewable sources of oils and polymers. However, one problem with using such biorenewable sources as refinery process feeds is that they are difficult to co-process with hydrocarbon feedstock, such as petroleum derived feedstock. Slurry hydrocracking of such feedstock turns out to be problematic.

Catalytic deoxygenation of biomass-derived pyrolysis oil typically leads to fouling of the catalyst and rapid plugging or clogging of the slurry hydrocracking reactor. It is contemplated that the formation of clogging components is due to thermal or acid catalysed polymerization of at least a portion of the hydrogen-deficient and chemically unstable components present in the biomass-derived pyrolysis oil, e.g. second order reactions in which at least a portion of these reactive species chemically interact creating either a glassy brown polymer or powdery brown char that limits run duration and processability of the biomass-derived pyrolysis oil. Thus, co-processing of pyrolysis oil and a hydrocarbon feedstock, such as a petroleum-based feedstock, typically leads to clogging of the inlet to the slurry hydrocracking reactor by e.g. said glossy brown polymer, which clogging in time needs to be removed mechanically, thereby causing maintenance stops in the production line. Clearly, such co-processing yields dissatisfactory results.

There is therefore a need to provide improved processes for refining combined feedstocks including biorenewable materials in conventional refining processes.

### SUMMARY

An object of the invention is to provide a process for producing a fuel precursor by hydrocracking of a combined feedstock comprising a hydrocarbon feedstock, such as a fossil feedstock, and a renewable feedstock to produce a fuel precursor. This object of the invention, as well as other objects apparent to a person skilled in the art after having studied the description below, are accomplished by a process of producing a hydrocracking product in a slurry hydrocracking reactor, in which process
a pyrolysis oil, a hydrocarbon feedstock, such as petroleum derived feedstock, and a hydrocracking catalyst is provided;
the pyrolysis oil is combined with the hydrocarbon feedstock, such as petroleum derived feedstock, and the hydrocracking catalyst, the pyrolysis oil being maintained at a temperature of less than 100° C. until the pyrolysis oil contacts both the hydrocarbon feedstock, such as petroleum derived feedstock, and the hydrocracking catalyst;
the hydrocarbon feedstock, such as petroleum derived feedstock, and the pyrolysis oil are hydrocracked in the slurry hydrocracking reactor in the presence of the hydrocracking catalyst and hydrogen gas.

The invention solves the problem of providing a process for producing a fuel precursor by co-processing a biorenewable feedstock and a hydrocarbon feedstock, such as petroleum derived feedstock, which can be run in existing infrastructure for upgrading of hydrocarbons, such as in slurry hydrocracking units. The inventors have realized that by providing a biorenewable pyrolysis oil having a temperature of less than 100° C., and a hydrocarbon feedstock, such as petroleum derived feedstock, to a slurry hydrocracking reactor, problems associated with plugging of the inlet of the slurry hydrocracking reactor can be alleviated. It is contemplated that the low temperature of the pyrolysis oil helps to cause less clogging in and adjacent to the slurry hydrocracking reactor by minimizing secondary polymerization reactions of the various components in the biomass-derived pyrolysis oil with themselves.

The inventors have surprisingly realized that by maintaining pyrolysis oil at a temperature of less than 100° C. until the pyrolysis oil contacts the hydrocarbon feedstock, such as petroleum derived feedstock, and the hydrocracking catalyst, clogging, or plugging, of the slurry hydrocracking reactor can be alleviated. It is contemplated that the low temperature of the pyrolysis oil lowers the reaction rates of secondary reactions between unstable compounds in the pyrolysis oil. Once the pyrolysis oil contacts the hydrocarbon feedstock, such as petroleum derived feedstock, and the hydrocracking catalyst, preferably in the slurry hydrocracking reactor, the temperature of the hydrocarbon feedstock, such as petroleum derived feedstock, is typically high enough to quickly raise the temperature of the pyrolysis oil to a temperature at which the primary cracking and deoxygenation reactions takes place at a much higher rate than the secondary polymerization reactions that causes plugging/clogging. This can be accomplished by combining the pyrolysis oil with the hydrocarbon feedstock, such as petroleum derived feedstock, and the hydrocracking catalyst in the slurry hydrocracking reactor, the contents of which typically has temperature of 300 to 600° C. It is also contemplated that this can be accomplished by combining the pyrolysis oil with a hot hydrocarbon feedstock, such as petroleum derived feedstock, being maintained at a temperature of at least 300° C. and hydrocracking catalyst in a vessel upstream the slurry hydrocracking reactor, followed by subsequent introduction into the reactor. Such secondary polymerization will thus take place only to a negligible amount as compared to primary hydrocracking reactions. By maintaining pyrolysis oil at a temperature of less than 100° C. until the pyrolysis oil contacts both the hydrocarbon feedstock, such as petroleum derived feedstock, and the hydrocracking catalyst, problems associated with plugging/clogging of the reactor due to secondary polymerization reactions can be significantly reduced. The production efficiency can thereby be significantly increased.

Alternatively, the pyrolysis oil may contact a portion of the hydrocarbon feedstock, such as petroleum derived feedstock, and the catalyst, wherein the pyrolysis oil, the portion of the hydrocarbon feedstock, such as petroleum derived feedstock, and the catalyst is maintained at a temperature of less than 100° C. until they enter the reactor. The temperature of the contents of the reactor will rapidly heat the pyrolysis oil, the portion of the hydrocarbon feedstock, such as petroleum derived feedstock, and the catalyst in the contents of the reactor.

Thus, the inventive process efficiently allows for efficient co-processing of hydrocarbon feedstock, such as petroleum derived feedstock, and pyrolysis oil in slurry hydrocracking reactors.

The hydrocarbon feedstock of the present invention may be any petroleum derived feedstock, biologically derived feedstock and/or recycled feedstock. Herein, the definition of “hydrocarbon feedstock” does not include the pyrolysis oil also provided in the process of the present disclosure.

The petroleum derived feedstock of the present invention can be any type of petroleum derived hydrocarbon stream that is known to be usefully processed in a slurry hydrocracking reactor. Examples of useful petroleum derived feedstock include, but are not limited to heavy oil vacuum bottoms, vacuum residue (VR), FCC slurry oil, vacuum gas oil (VGO) and other heavy hydrocarbon-derived oils.

The biologically derived feedstock can be any type of biologically derived feedstock that can be usefully processed in a slurry hydrocracking reactor. The term biologically indicates that it results from conversion of renewable organic material. Examples of such biologically derived feedstocks include, but are not limited to, hydrothermal liquefication oils and lignin oil.

The recycled feedstock may be a feedstock obtained from the slurry hydrocracking process disclosed herein, or recycled from other processes in a refinery where the slurry hydrocracking process takes place. Examples of recycled feedstock include heavy and/or unconverted fractions from the slurry hydrocracking process, or from other processes in the refinery.

Thus, when the present disclosure refers to a hydrocarbon feedstock, it may refer to either a petroleum derived feedstock as defined above, a biologically derived feedstock as defined above, a recycled feedstock as defined above, or a mixture thereof.

The hydrocarbon feedstock may further comprise particles of biomass, such as particles of lignin, sawdust, forest residue and/or plant parts.

Herein, the term “pyrolysis oil” refers to a crude or refined oil resulting from pyrolysis of organic material.

Pyrolysis is a thermochemical decomposition of organic material, such as sawdust or disposed tyres, at elevated temperature in the absence of oxygen. Pyrolysis may involve thermal pyrolysis, catalytic pyrolysis or hydrogen pyrolysis.

Herein, the term “slurry hydrocracking reactor” refers to a reactor suitable for slurry hydrocracking. Slurry hydrocracking is typically performed in an agitated tank reactor, such as a reactor, for example a continuous stirred-tank reactor. To the reactor, a mixture of catalyst, feedstock and hydrogen is fed at high pressure (100-200 bar) and high temperature (300-600° C.). The catalyst may be finely dispersed in the feedstock, thus creating a slurry through which hydrogen is bubbled in a continuous process. The size and degree of dispersion of the catalyst strongly influence its activity. Usually the catalyst is introduced as fine powders or as soluble pre-cursors that are transformed to nano- or micrometer sized particles in the process. Sulfides of molybdenum are often used as catalysts, but also other metal sulfides such as copper and iron are used. These well-dispersed catalysts maximize the interaction between hydrogen and oil compared to traditional catalysts that are deposited on support materials. The slurry process is therefore less sensitive to catalyst deactivation compared to traditional fixed bed processes, where coke (and metal) deposition in the pores of the support material is considered the main reason for catalyst deactivation. The slurry reactor configuration also enables improved heat control compared to packed bed reactors.

In general, “hydrocracking” is a catalytic chemical process used in refineries to convert complex hydrocarbon molecules into simpler molecules by addition of hydrogen under high pressure. Hydrocracking is performed in a hydrocracking zone in the refinery which contains hydrogen gas and catalyst. The catalyst can be distributed to the reactants in a number of ways, for example by a fixed catalyst bed through which reactants flow and convert to simpler molecules.

In “slurry hydrocracking”, the catalyst is dispersed in at least part of the reactants and introduced into the slurry hydrocracking zone with said part of the reactants. The hydrocracking zone contains hydrogen gas and has a temperature of from 300 to 600° C. and a pressure of from 100-200 bar. Thus, the hydrocracking zone provides conditions under which the reactants are converted to simpler molecules suitable for use in transportation fuels, or at least suitable for further processing into transportation fuels.

The feeding of the hydrocarbon feedstock, such as petroleum derived feedstock, and the pyrolysis oil to the slurry hydrocracking reactor may be performed through separate feed lines. Alternatively, the feedstocks may be mixed prior to the reactor and enter the reactor through a common feedline. However, the temperature of the pyrolysis oil will be kept at a temperature of below 100° C. until the pyrolysis oil has been combined with the hydrocarbon feedstock, such as petroleum derived feedstock, and the catalyst. Upon entry into the reactor, or upon contact with a hot hydrocarbon feedstock, such as a hot petroleum derived stream, the temperature of the pyrolysis oil is rapidly heated and dispersed in the agitated hot content in the slurry reactor without any operating issues relating to clogging.

A hydrogen containing gas is added to the slurry hydrocracking reactor to maintain a hydrocracking pressure within the desired range. The hydrogen containing gas may be essentially pure hydrogen or it may include additives such as hydrogen sulfide impurity or recycle gases such as light hydrocarbons. Reactive or non-reactive gases may be combined with hydrogen and introduced into the slurry hydrocracking reactor to maintain the reactor at the desired pressure and to achieve the desired hydrocracking reaction products. The useful hydrocracking reaction pressures will typically range from 100-200 bar, such from 120-200 bar, preferably from 150-200 bar. The liquid hourly space velocity (LHSV) in the reactor may be in the range of from 0.25 to 5 h⁻¹, such as in the range of from 0.5 to 2 h⁻¹.

The catalyst used in the process of this invention may be any catalyst that is known to be useful in a hydrocracking reaction process and in particular in a slurry hydrocracking reaction. During the hydrocracking reaction, the slurry hydrocracking reactor contains a catalyst. The catalyst may be contained in the reactor at the start of the process. A catalyst may also be fed to the slurry hydrocracking reactor. If the catalyst is fed to the slurry hydrocracking reactor, the catalyst feed is typically fed to the reactor with the hydrocarbon feedstock, such as petroleum derived feedstock, and/or the pyrolysis oil. However, the catalyst feed can include an active catalyst, and/or catalyst precursor ingredients. In other words, the catalyst feed does not have to include an active catalyst. Instead, the catalyst feed may include ingredient(s) that react together or that react with ingredients in the combined feed or in the hydrocracking reactor to form an active hydrocracking catalyst in the hydrocracking reactor. Some examples of useful classes of hydrocracking catalysts include, but are not limited to, heterogeneous solid powder catalysts, homogeneous water soluble dispersed catalysts, oil soluble dispersed catalysts. Homogeneous and heterogeneous catalysts may in particular be metals such as cobalt, molybdenum, nickel, iron, vanadium, tin, copper, ruthenium and other Group IV-VIII transition metal containing catalysts. Fine catalytic powders such as powdered coals, bauxite and limonite may be used as well. The metals can be added to the hydrocracking reaction zone in many forms including as metal salts like ammonium heptamolybdate, and iron sulfate. Suitable oil soluble catalyst precursors include oil soluble molybdenum hexacarbonyl, molybdenum 2-etylhexanoate (also known as octoate) and molybdenum naphthenate, to be sulfided in-situ in the reactor to MoS₂.

The amount of catalyst in the process may be less than 10% by weight of the combined weight of the hydrocarbon feedstock and the pyrolysis oil, such as less than 5% by weight of the combined weight of the hydrocarbon feedstock and the pyrolysis oil, such as less than 1% by weight of the combined weight of the hydrocarbon feedstock and the pyrolysis oil, such as less than 0.5% by weight of the combined weight of the hydrocarbon feedstock and the pyrolysis oil. Preferably, the amount of catalyst in the process may be in the range of 0.005-1% by weight of the combined weight of the hydrocarbon feedstock and the pyrolysis oil, such as in the range of 0.01-0.5% by weight of the combined weight of the hydrocarbon feedstock and the pyrolysis oil, such as in the range of 0.05-0.5% by weight of the combined weight of the hydrocarbon feedstock and the pyrolysis oil. Slurry hydrocracking is advantageous in that relatively small amounts of catalyst is used, as compared to for example fluid catalytic cracking processes.

The catalyst may be present in either the hydrocarbon feedstock, such as petroleum derived feedstock, or the pyrolysis oil. The catalyst may also be present in both the hydrocarbon feedstock, such as petroleum derived feedstock, and the pyrolysis oil.

The reaction will take place at hydrocracking reaction conditions sufficient to obtain the hydrocracking product comprising a light hydrocarbon yield from the combined feed. Thus, the reaction is typically a hydrocracking reaction at which the feedstocks are cracked in the presence of hydrogen to lower molecular weight products. The reaction conditions will generally include temperatures ranging from 300 to 600° C., such as from 350 to 500° C., such as from 350 to 450° C., such as from 375 to 425° C., such as from 425 to 500° C. The hydrocracking product comprises a light hydrocarbon yield including naphta and light hydrocarbons having a boiling point in the range of 177-343° C.

Hydrocracking conditions may include agitation in the reactor. A continuous stirred-tank reactor, for example, provides suitable agitation by means of continuous stirring or continuous pumping, in which the contents of the reactor are pumped to provide suitable agitation in the reactor. The hydroconversion reaction conditions include the presence of hydrogen in the reactor.

After the hydrocracking reaction, a hydrocracking product stream may be removed from the slurry hydrocracking reactor and further processed in downstream processes to concentrate and recover high value hydrocarbons (i.e. fuel precursors) from the liquid hydrocracking product stream. In most cases, the liquid product stream will be used as is or will be fractionated and the separated components used as feedstocks for traditional refinery processes. The term “fuel precursor” refers to high value hydrocarbons suitable for admixture with other hydrocarbons to produce e.g. a gasoline or a diesel fuel. The fuel precursor of the present invention comprises naphta and light hydrocarbons.

The hydrocracking product of the present invention comprises a higher proportion of gas and light hydrocarbons as compared to hydrocracking product produced by slurry hydrocracking of conventional petroleum-derived feedstocks.

In some embodiments, the pyrolysis oil is maintained at a temperature of less than 100° C. until the pyrolysis oil contacts both the hydrocarbon feedstock, such as petroleum derived feedstock, and the hydrocracking catalyst in the presence of hydrogen gas. The slurry hydrocracking zone of the present invention contains hydrogen gas. Hydrogen gas can be provided to the slurry hydrocracking zone through a separate feed line, or via the feed line(s) that introduces the reactants to the hydrocracking zone.

In some examples, the pyrolysis oil is simultaneously combined with the hydrocarbon feedstock, such as petroleum derived feedstock, and the hydrocracking catalyst, for example by suspending the hydrocracking catalyst in the hydrocarbon feedstock, such as petroleum derived feedstock. Thus, when combining the pyrolysis oil and the hydrocarbon feedstock, such as petroleum derived feedstock, the pyrolysis oil will contact the hydrocarbon feedstock, such as petroleum derived feedstock, and the hydrocracking catalyst simultaneously.

In some examples, the pyrolysis oil is combined with the hydrocracking catalyst and the hydrocarbon feedstock, such as petroleum derived feedstock, in sequence. This can be accomplished by suspending the hydrocracking catalyst in the pyrolysis oil.

In some embodiments, the pyrolysis oil and the hydrocarbon feedstock, such as petroleum derived feedstock, is introduced to the hydrocracking reactor through separate feed lines. Thus, the pyrolysis oil is combined with the hydrocarbon feedstock, such as petroleum derived feedstock, in the hydrocracking reactor. This is advantageous in that it allows for a simple reactor construction, in which the high temperature of the reactor is utilized to quickly heat the cold pyrolysis oil upon contact with the hydrocarbon feedstock, such as petroleum derived feedstock. Alternatively, in some embodiments, the pyrolysis oil is combined with the hydrocarbon feedstock, such as petroleum derived feedstock, upstream the slurry hydrocracking reactor to form a combined feed; the combined feed subsequently being introduced to the slurry hydrocracking reactor.

In some embodiments the pyrolysis oil is combined with the hydrocarbon feedstock, such as petroleum derived feedstock, under agitation, such as under stirring or under pumping. Slurry hydrocracking is preferably performed under agitation, for example by continuous stirring or pumping. In some embodiments, the catalyst is dispersed in the hydrocarbon feedstock, such as petroleum based feedstock, and introduced into the slurry hydrocracking reactor with the hydrocarbon feedstock, such as petroleum based feedstock. Alternatively, the catalyst is dispersed in the pyrolysis oil and introduced into the slurry hydrocracking reactor with the pyrolysis oil.

In some embodiments, the slurry hydrocracking reactor is provided with a pump or a stirrer for agitating the content of the reactor.

In some embodiments, the combined feed comprises 5-50 wt.-% pyrolysis oil. The ratio between the pyrolysis oil and the hydrocarbon feedstock, such as petroleum-derived feedstock, in the combined feedstock may vary significantly, and the combined feed may comprise 5-40 wt-% pyrolysis oil, such as 10-30 wt-% pyrolysis oil, preferably 15-25 wt. % pyrolysis oil. Thus, a significant amount of petroleum-derived feedstock can be replaced by biorenewable pyrolysis oil, thereby lowering the fossil content of the provided fuel precursor.

In some embodiments, the temperature of the pyrolysis oil is in the range of 10-90° C. until said pyrolysis oil contacts both the hydrocarbon feedstock, such as petroleum derived feedstock, and the hydrocracking catalyst. By feeding the reactor with cold pyrolysis oil, problems associated with clogging of the reactor may be alleviated. The high temperature of the reactor contents, and optionally agitation which provides a rapid dispersion of the reactor contents, quickly heats the pyrolysis oil to the desired reaction temperature.

The temperature of the pyrolysis oil may be in the range of 10-80° C., such as in the range of 10-70° C., preferably in the range of 10-60° C., until said pyrolysis oil contacts both the hydrocarbon feedstock, such as petroleum derived feedstock, and the hydrocracking catalyst, optionally in the presence of hydrogen gas. The inventors have found that a temperature of the pyrolysis in the range of 10-50° C. until said pyrolysis oil contacts both the hydrocarbon feedstock, such as petroleum derived feedstock, and the catalyst causes very little clogging of the reactor.

In some examples, temperature of the pyrolysis oil may be in the range of 20-50° C., such as in the range of 30-50° C., preferably in the range of 40-50° C., until said pyrolysis oil contacts both the hydrocarbon feedstock, such as petroleum derived feedstock, and the catalyst.

In some examples, the hydrocarbon feedstock, such as petroleum derived feedstock, is mixed with at least one catalyst before being introduced to the slurry hydrocracking reactor. This is advantageous in that it provides for a good dispersion of the catalyst particles in the feedstock already upon entry of the feedstock to the reactor. Since the hydrocarbon feedstock, such as petroleum derived feedstock, typically makes up for the majority of the combined feedstock, it is advantageous to provide the catalyst to the reactor as a mixture with the hydrocarbon feedstock, such as petroleum derived feedstock.

In some embodiments, the petroleum derived feedstock, further comprises vacuum residue (VR) and/or vacuum gas oil (VGO). The reactants introduced into the reactor may thus comprise VR, VGO and pyrolysis oil, preferably in an amount of 35-65 wt-% VR, 15-45 wt-% VGO and 5-35 wt-% pyrolysis oil. Alternatively, the reactants comprise 50-95 wt-% VR, 5-45 wt-% VGO, and 5-25 wt-% pyrolysis oil. It has surprisingly been found that the pyrolysis oil is highly suitable for co-processing along with a petroleum-derived feed comprising VR and VGO, under the process conditions disclosed herein.

Vacuum residue (VR) is the bottom product obtained from the vacuum distillation unit in a petroleum refinery. It is usually the heaviest and most contaminated stream obtained in the refinery and sometimes called the bottom-of-the-barrel or vacuum pitch. Vacuum gas oil (VGO) is a hydrocarbon stream recovered from one or more petroleum refinery unit operations typically as a side cut from a vacuum column, a crude column and/or a coker column. VGO contains a large quantity of cyclic and aromatic compounds as well as heteroatoms, such as sulphur and nitrogen, and other heavier compounds, depending on the crude source and VGO cut. VGO can include, for example, light vacuum gas oil, heavy vacuum gas oil, heavy coker gas oil, light coker gas oil, and/or heavy atmospheric gas oil.

In some embodiments, the pyrolysis oil is a biomass derived pyrolysis oil. Herein, the term “biomass derived pyrolysis oil” refers to a crude or refined oil resulting from pyrolysis of renewable organic material. Biomass derived pyrolysis oil may be produced, such as, for example, from pyrolysis of biomass in a pyrolysis reactor. Virtually any form of biomass can be used for pyrolysis to produce a biomass-derived pyrolysis oil. The biomass-derived pyrolysis oil may be derived from biomass material, such as, wood, agricultural waste, nuts and seeds, algae, forestry residues, and the like. The biomass derived pyrolysis oil may be obtained by different modes of pyrolysis, such as, for example, fast pyrolysis, vacuum pyrolysis, catalytic pyrolysis, and slow pyrolysis or carbonization, and the like. The composition of the biomass-derived pyrolysis oil can vary considerably and depends on the feedstock and processing variables. Biomass derived pyrolysis oil is complex liquid, consisting of a wide range of different compounds including water, aldehydes, ketones, furfurals, carboxylic acids, sugar-like material and lignin-derived compounds with a wide range of molecular weights and boiling points.

In some embodiments, the hydrocarbon feedstock, such as petroleum derived feedstock, and the pyrolysis oil are provided to the reactor through separate feed lines. Thus, the first time the pyrolysis oil contacts both the hydrocarbon feedstock, such as petroleum derived feedstock, and the catalyst is in the slurry hydrocracking reactor. The catalyst particles may be present in either the hydrocarbon feedstock, such as petroleum derived feedstock, or the pyrolysis oil. It may also be present in both the hydrocarbon feedstock, such as petroleum derived feedstock, and the pyrolysis oil.

This is advantageous in that it allows for the hydrocarbon feedstock, such as petroleum derived feedstock, to be heated upon entry into the reactor, such that the temperature of the reactor is not significantly lowered when the hydrocarbon feedstock, such as petroleum derived feedstock, is being fed to the reactor.

In some examples, the pyrolysis oil and the hydrocarbon feedstock, such as petroleum derived feedstock, can be combined in a mixing vessel situated upstream and in fluid connection with the reactor. Thus, the pyrolysis oil is combined with the hydrocarbon feedstock, such as petroleum derived feedstock, before entry into the reactor. In some embodiments is the reacting in the slurry hydrocracking reactor performed at a temperature in the range of 350-500° C. The hydrocracking reaction may take place under hydrocracking reaction conditions sufficient to obtain the desired light hydrocarbon yield from the combined feed.

In some embodiments, the slurry hydrocracking reactor is a continuous agitated reactor, such as stirred-tank reactor (CSTR). Such reactors are known to the person skilled in the art. The agitation may be provided by a stirrer or a pump. Agitated reactors have proven to be advantageous in the co-processing described herein.

In some embodiments, the hydrocracking also forms C1-C3 hydrocarbons. The process may further comprise upgrading said C1-C3 hydrocarbons to form hydrogen gas. The process may further comprise recirculating the hydrogen gas from said upgrading to the slurry hydrocracking reactor. It has been realized that the hydrocracking of pyrolysis oil increases the amount of C1-C3 hydrocarbons formed, as compared to the hydrocracking of petroleum derived feedstock. Thus, by recycling some of the hydrogen to the slurry hydrocracking reactor, the total amount of hydrogen used in the process can be lowered.

The objects of the invention are also accomplished by a hydrocracking product, such as a fuel precursor or a hydrocarbon refinery intermediate, obtainable by the process defined in any one of claims 1-15. The hydrocracking product has an increased proportion of light hydrocarbons as compared to hydrocracking products of pure fossil feeds.

### EXAMPLES

### Process Equipment

The tests below were run in a slurry hydrocracking (SHC) pilot plant provided with a continuous stirred-tank reactor (CSTR). Vacuum gas oil, pyrolysis oil and catalyst feedstock were continuously mixed in the slurry tank by a stirrer and then fed to a SHC reactor by a syringe pump being equipped with a stirrer to ensure a homogenous feed. Vacuum residue was fed separately to the reactor by a gear pump.

### Materials

A first feed comprising 50 wt. % vacuum residue (VR) and 50 wt. % vacuum gas oil (VGO) was provided.

A second feed comprising 50 wt. % VR, 30 wt. % VGO and 20 wt. % fast pyrolysis bio oil (FPBO) from BTG BV was provided.

The properties of the feedstocks are presented in Table 1. Molybdenum 2-ethylhexanoate was chosen as catalyst for the trials at a Mo concentration of 0.1 wt. % of the total feed.

TABLE 1
Properties of raw materials used in this study. All
numbers are given as wt. % unless otherwise stated.

| | | | | Method | Method |
|---|---|---|---|---|---|
| Component | VR | VGO | FPBO | VR/VGO | FPBO |
| C (%) | 85.0 | 85.3 | 49.2 | Dumas | ASTM D |
| | | | | Combustion | 1744 |
| H (%) | 10.5 | 12.1 | 7.3 | Dumas | ASTM D |
| | | | | Combustion | 1744 |
| N (%) | 0.8 | 0.2 | 0.3 | Dumas | ASTM D |
| | | | | Combustion | 1744 |
| S (%) | 3.3 | 1.2 | 0.0 | Dumas | ASTM D |
| | | | | Combustion | 1552 |
| O (%) | 0.7 | 0.4 | 43.2 | Unterzaucher | Calculated |
| | | | | Pyrolysis | by |
| | | | | | difference |
| Water (%) | — | — | 28 | — | ASTM |
| | | | | | D203 |
| TAN | — | — | 87.2 | — | ASTM |
| (mg KOH/g) | | | | | D664-11a |
| Asphaltene | 6.3 | — | — | ASTM D | — |
| (%) | | | | 6560 | |
| Residue | 85.8 | 1.0 | — | ASTM D | — |
| (% >524° C.) | | | | 7169 | |
| VGO | 14.2 | 77.9 | — | ASTM D | — |
| (% 343-524° C.) | | | | 7169 | |
| Distillates | 0 | 20.6 | — | ASTM D | — |
| (% 177-343° C.) | | | | 7169 | |
| Naphtha | 0 | 0.5 | — | ASTM D | — |
| (% IBP-177° C.) | | | | 7169 | |

Continuous Trials

Corresponding trials were performed for both the first feed and for the second feed. “Continuous” refer to that the trials were carried out with a continuous feed of reactants, catalyst and hydrogen to the CSTR reactor and a continuous withdrawal of reaction products (solid, liquid and gas) as opposed to typical laboratory experiments using autoclaves in which experiments are carried out in batch mode.

A first trial with the first feed was performed. In the reactor VGO and catalyst was filled to a liquid level of approximately 80%. To leak test the system it was pressurized with nitrogen to 150 bar and then left overnight. Stirring was maintained at 670 rpm from when the reactor lid was closed until the experiment was initiated. Once the system was determined leak tight, nitrogen was gently released until the system was unpressurized.

A heating phase followed. During the heating phase the reactor contained only the VGO and catalyst filled prior to closing the reactor. Once liquid temperature in the reactor reached 450° C., feeding of VR through a dip tube and; feeding of a slurry of VGO and catalyst was initiated, with the total flow rate corresponding to a residence time in the reactor of about 1.5 h. Reaction pressure was maintained at 150 bar, hydrogen flow at 800 NL/h, stirring at 1340 rpm throughout the trial from initial heating to shut down. The catalyst slurry was fed through the bottom inlet and VR through the dip tube. Liquid products were collected, and the outlet gas monitored and analysed.

After feeding raw material to the reactor for about 7.5 h (5 replacements of the reactor volume), the product tanks were emptied in order to start collecting product at stable conditions for the remainder of the trial. The process was maintained at stable conditions for another 13 hours after this and samples of the liquid product were collected every third hour by redirecting the product flow from the product tanks to sample bottles.

A second trial with the second feed was also performed. This trial differed from the reference trial in that the catalyst slurry comprised catalyst, VGO and pyrolysis oil. The temperature of the catalyst slurry feed tank and feed line was maintained at about 45° C.

The experimental parameters are summarized in Table 2 (first trial) and Table 3 (second trial).

TABLE 2
Summarized experimental parameters for the first trial.

| Parameter | Value |
|---|---|
| Wt. % VR in feed | 50 |
| Wt. % VGO in feed | 50 |
| Wt. % FPBO infeed | 0 |
| LHSV (h⁻¹) | 0.71 |
| Catalyst | Molybdenum 2-etylhexanoate |
| Catalyst Loading (% Mo) | 0.1 |
| Temperature (° C.) | 450 |
| Pressure (bar) | 150 |
| Hydrogen flow (Ndm³/h) | 800 |

TABLE 3
Summarized experimental parameters for second trial.

| Parameter | Value |
|---|---|
| Wt. % VR in feed | 50 |
| Wt. % VGO in feed | 30 |
| Wt. % FPBO in feed | 20 |
| LHSV (h⁻¹) | 0.64 |
| Catalyst | Molybdenum 2-etylhexanoate |
| Catalyst Loading (% Mo) | 0.1 |
| Temperature (° C.) | 450 |
| Pressure (bar) | 150 |
| Hydrogen flow (Ndm³/h) | 800 |

The liquid products were then analysed using the methods of Table 4.

TABLE 4
Analysis methods used for characterization of products.

| Property | Analysis Method |
|---|---|
| Elemental Composition | Dumas Combustion (Elemental |
| (CHN) | Microanalysis, UK) |
| Elemental Composition | Mitsubishi NSX-2100V with automatic |
| (S) | liquid injector (ASC-250L), vertical |
| | furnace (VF-210) and UV-fluorescence |
| | detector (SD-210) |
| Elemental Composition | Unterzaucher Pyrolysis (Elemental |
| (O) | Microanalysis, UK) |
| Total acid number | ASTM D664-11a |
| (TAN) | |
| Boiling point | ASTM 7169 (Heavy oil product) and |
| distribution | ASTM 2887 (Light oil product) |
| Asphaltene in heavy | ASTM D6560 (Uniper, Sweden) |
| oil product | |
| ¹⁴C content | ISO 13822: 2013 (Tandem Laboratory, |
| | Sweden) |
| Water content | ASTM E203-16 (Only analyzed in water |
| | fraction) |

The results of the analysis are presented in Table 5.

TABLE 5
Summary of the continuous test trials.

| | | |
|---|---|---|
| VR/VGO/FPBO | 50:50:0 | 50:30:20 |
| Wt. % VR in feed (%) | 50.6 | 48.9 |
| LHSV (h⁻¹) | 0.71 | 0.64 |
| Total mass balance (%) | 94.6 | 96.9 |
| H₂ Consumption (g/kg feed) | 6.5 | 14.8 |
| Total oil product yield (%) | 90.1 | 76.8 |
| UCO (>524° C.) (%) | 10.1 | 6.4 |
| VGO (343-524° C.) (%) | 38.4 | 24.8 |
| Distillates (177-343° C.) (%) | 26.8 | 26.4 |
| Naphtha (IBP-177° C.) (%) | 14.8 | 19.2 |
| Water (%) | — | 7.8 |
| Total Sediment yield (%) | 1.62 | 1.38 |
| Coke (%) | 0.95 | 0.86 |
| Asphaltene Sediment (%) | 0.67 | 0.52 |
| Total gas yield (%) | 8.2 | 14.0 |
| CH₄ (%) | 2.4 | 3.7 |
| C₂H₆ (%) | 1.5 | 2.6 |
| C₃H₈ (%) | 2.5 | 3.6 |
| H₂S (%) | 1.9 | 1.9 |
| CO₂ (%) | — | 1.8 |
| CO (%) | — | 0.5 |
| VR Conversion (%) | 76.0 | 84.3 |
| Asphaltene Conversion (%) | 46.5 | 45.2 |
| HDS (%) | 43.2 | 58.3 |
| HDO (%) | 33.1 | 91.7 |
| H/C mass ratio | 0.134 | 0.131 |
| O (%) | 0.39 | 0.99 |
| S (%) | 1.44 | 1.05 |
| N (%) | 0.63 | 0.73 |
| TAN (mg KOH/g) | 0.057 | 0.23 |
| Proportion C14 (%) | — | 8.6 |

### Itemized List of Embodiments

1. A process of producing a hydrocracking product in a slurry hydrocracking reactor, in which process
   a pyrolysis oil, a petroleum derived feedstock, and a hydrocracking catalyst is provided;
   the pyrolysis oil is combined with the petroleum derived feedstock and the hydrocracking catalyst, the pyrolysis oil being maintained at a temperature of less than 100° C. until the pyrolysis oil contacts both the petroleum derived feedstock and the hydrocracking catalyst;
   the petroleum derived feedstock and the pyrolysis oil are hydrocracked in the slurry hydrocracking reactor in the presence of the hydrocracking catalyst and hydrogen gas.
2. The process according to item 1, wherein the pyrolysis oil is maintained at a temperature of less than 100° C. until the pyrolysis oil contacts both the petroleum derived feedstock and the hydrocracking catalyst in the presence of hydrogen gas.
3. The process according to any one of items 1-2, wherein the pyrolysis oil and the petroleum derived feedstock is introduced to the slurry hydrocracking reactor through separate feed lines.
4. The process according to any one of items 1-2, wherein the pyrolysis oil is combined with the petroleum derived feedstock upstream the slurry hydrocracking reactor to form a combined feed; the combined feed subsequently being introduced to the slurry hydrocracking reactor.
5. The process according to any one of the preceding items, wherein the hydrocracking catalyst is present in the petroleum based feedstock.
6. The process according to any one the preceding items, wherein the hydrocracking catalyst is present in the pyrolysis oil.
7. The process according to any one of the preceding items, wherein the pyrolysis oil is combined with the petroleum derived feedstock under agitation, such as under stirring or under pumping.
8. The process according to any one of the preceding items, wherein the slurry hydrocracking reactor is provided with a pump or a stirrer.
9. The process according to any one of the preceding items, wherein the slurry hydrocracking reactor is a continuous stirred-tank reactor.
10. The process according to any one of the preceding items, wherein the pyrolysis oil is maintained at a temperature in the range of 10-90° C., preferably in the range of 10-60° C., more preferably in the in the range of 10-50° C., until the pyrolysis oil contacts both the petroleum derived feedstock and the hydrocracking catalyst, optionally in the presence of hydrogen gas.
11. The process according to any one of the preceding items, wherein the petroleum derived feedstock comprises vacuum residue (VR) and/or vacuum gas oil (VGO).
12. The process according to any one of the preceding items, wherein the pyrolysis oil is a biomass derived pyrolysis oil.
13. The process according to any one of the preceding items, wherein the hydrocracking also forms C1-C3 hydrocarbons, and wherein the process further comprises upgrading the C1-C3 hydrocarbons to form hydrogen gas, and recirculating the hydrogen gas from the upgrading to the slurry hydrocracking reactor.
14. A fuel precursor obtainable by the process as defined in any one of items 1-13.

1. A process of producing a hydrocracking product in a slurry hydrocracking reactor, in which process
a pyrolysis oil, a hydrocarbon feedstock, and a hydrocracking catalyst is provided;
the pyrolysis oil is combined with the hydrocarbon feedstock and the hydrocracking catalyst, the pyrolysis oil being maintained at a temperature of less than 100° C. until the pyrolysis oil contacts both the hydrocarbon feedstock and the hydrocracking catalyst;
the hydrocarbon feedstock and the pyrolysis oil are hydrocracked in the slurry hydrocracking reactor in the presence of the hydrocracking catalyst and hydrogen gas.

2. The process according to claim 1, wherein the pyrolysis oil is maintained at a temperature of less than 100° C. until the pyrolysis oil contacts both the hydrocarbon feedstock and the hydrocracking catalyst in the presence of hydrogen gas.

3. The process according to claim 1, wherein the pyrolysis oil and the hydrocarbon feedstock is introduced to the slurry hydrocracking reactor through separate feed lines.

4. The process according to claim 1, wherein the pyrolysis oil is combined with the hydrocarbon feedstock upstream the slurry hydrocracking reactor to form a combined feed; the combined feed subsequently being introduced to the slurry hydrocracking reactor.

5. The process according to claim 1, wherein the hydrocracking catalyst is present in the hydrocarbon feedstock.

6. The process according to claim 1, wherein the hydrocracking catalyst is present in the pyrolysis oil.

7. The process according to claim 1, wherein the pyrolysis oil is combined with the hydrocarbon feedstock under agitation, such as under stirring or under pumping.

8. The process according to claim 1, wherein the slurry hydrocracking reactor is provided with a pump or a stirrer.

9. The process according to claim 1, wherein the slurry hydrocracking reactor is a continuous stirred-tank reactor.

10. The process according to claim 1, wherein the pyrolysis oil is maintained at a temperature in the range of 10-90° C., preferably in the range of 10-60° C., more preferably in the in the range of 10-50° C., until the pyrolysis oil contacts both the hydrocarbon feedstock and the hydrocracking catalyst, optionally in the presence of hydrogen gas.

11. The process according to claim 1, wherein the hydrocarbon feedstock is a petroleum derived feedstock, a biologically derived feedstock and/or a recycled feedstock, and optionally wherein the petroleum derived feedstock comprises vacuum residue (VR) and/or vacuum gas oil (VGO).

12. The process according to claim 1, wherein the pyrolysis oil is a biomass derived pyrolysis oil.

13. The process according to claim 1, wherein the hydrocracking also forms C1-C3 hydrocarbons, and wherein the process further comprises upgrading the C1-C3 hydrocarbons to form hydrogen gas, and recirculating the hydrogen gas from the upgrading to the slurry hydrocracking reactor.

14. The process according to claim 1, wherein the amount of hydrocracking catalyst in the process is less than 10% by weight of the combined weight of the hydrocarbon feedstock and the pyrolysis oil.

15. The process according to claim 1, wherein the liquid hourly space velocity (LHSV) in the reactor is in the range of from 0.25 to 5 h⁻¹, such as in the range of from 0.5 to 2 h⁻¹.

16. A fuel precursor obtainable by the process as defined in claim 1.
